(19) United States
(12) Patent Application Publication
(10) Pub. No.: US 2016/0023508 A1
(43) Pub. Date: Jan. 28, 2016

(54) MATERIAL SHEET WITH DECORATIVE LAYER AND EMBOSSING

(71) Applicant: Thomas Niedermaier, Enger (DE)

(72) Inventor: Thomas Niedermaier, Enger (DE)

(73) Assignee: Hueck Rheinische GmbH, Viersen (DE)

(21) Appl. No.: 14/875,580

(22) Filed: Oct. 5, 2015

Related U.S. Application Data
(62) Division of application No. 14/056,155, filed on Oct. 17, 2013.
Application No. 14/056,155 is a division of application No. 12/804,804, filed on Jul. 29, 2010, now abandoned.

(51) Int. Cl. B44F 9/02; B32B 29/00; B32B 38/06; B32B 21/02; B32B 21/06; B44C 5/06; B32B 3/30; B32B 21/14

(52) U.S. Cl. CPC B44F 9/02; B32B 3/30; B32B 29/002; B32B 21/14; B32B 21/02; B32B 21/06; B44C 5/06; B32B 38/06; B32B 2479/00; B32B 2451/00; B32B 2307/412; B32B 2471/00; B32B 2317/12; B32B 2317/16

(57) ABSTRACT

A material sheet in particular for producing furniture, including at least one center substrate layer, and a decorative layer at least on one side of the substrate layer. The decorative layer is disposed on both sides of the material sheet to be produced and a precise embossing is provided. The structures on both sides of the material sheet are configured precisely aligned.

### RELATED APPLICATIONS

This patent application is a divisional of U.S. patent application Ser. No. 14/056,155 filed on Oct. 17, 2013 which is a divisional of U.S. patent application Ser. No. 12/804,804 filed on Jul. 29, 2010.

### FIELD OF THE INVENTION

The invention relates to a material sheet, in particular for producing furniture, including at least a center substrate layer and a decorative layer on at least one side of the substrate layer and a press plate for producing the material sheet.

Material sheets of this type are typically used for producing furniture, door elements or floor panels. A fibrous material is used to produce material sheets, wherein the material is coated with plural layers at least on one side, advantageously on both sides, wherein the layers are connected with one another in a press. Therefore, the layers are impregnated with an amino resin, e.g. a melamine formaldehyde resin, so that the amino resin layer can harden during the pressing process while heat is applied simultaneously, so that a connection of the particular layers with the substrate layer is established. The layers thus used are at least made from a decorative layer and an overlay layer. The decorative layer can include an ornamental pattern or a replication of a natural wood surface or of a natural rock surface.

Advantageously the material sheets are used for producing furniture, wherein it is essential that the selected pattern, preferably a wood grain pattern, is reproduced as authentically as possible. Therefore, press plates are being used which include a negative profile of the material sheets to be pressed. Thus, the structure of the press plate can be transferred into the upper cover layer of the substrate layer during the pressing process. Typically, large press plates with a size of 2.3×6 m are being used for producing large size material sheets, which can then be cut in the furniture industry for the respective application.

Customer requirements for such material sheets are increasing continuously, wherein it is again and again paramount that the surface configuration is as close as possible to a natural veneer. Therefore, in order to sufficiently consider customer requirements in this direction, additional improvements of the material sheets are necessary.

### BRIEF SUMMARY OF THE INVENTION

Thus, it is the object of the present invention to provide a material sheet which provides improved quality.

In order to achieve the object, it is provided to dispose a decorative layer on both sides of the material sheet to be produced and to provide a precise embossing, wherein the structures are precisely aligned on both sides of the material sheet. Further embodiments of the invention can be derived by including the following:
an embossing on a front side and on a backside of the material sheet, and wherein at least one of the decorative layers includes at least a decorative paper;
the decorative paper and the embossing includes a symmetrical structure which starts in a center and extends in a longitudinal direction and in a transversal direction;
a glue layer is disposed between the center substrate layer and at least one of the decorative layers on at least one side, preferably on both sides;
an underlay layer is disposed between the center substrate layer and at least one of the decorative layers on at least one side, preferably on both sides;
at least one of the decorative layers and/or overlay layers include abrasion resistant particles;
at least a layer sequence of an overlay layer, a decorative layer and an underlay layer are provided on both sides of the material sheet;
wherein the overlay layers are transparent; and
the material sheet includes fibrous materials like MDF, HDF, particleboard, OSB and plywood,
   each taken alone or in combination.

A precisely aligned embossing is in particular an embossing where the pattern of the decorative layer, e.g. a wood grain pattern, coincides with the structure embossed by the press plate. Thus, the wood pores can be emphasized in particular through respective depth embossing, so that overall an impression of natural wood is generated, so that a tactile sensation is furthermore created through the provided embossing, which conveys the impression of a natural wood material to a person in particular when touching the surface.

In the present application, the material sheets are mostly used for producing pieces of furniture. In particular when the furniture is not open shelving, it is provided with door elements, which are pivotably supported through hinges. Thus, the appearance of a material sheet can be improved with respect to its quality in that the structure is provided precisely aligned on both sides of the material sheet. Precisely aligned in this context means that the wood grain on the front is mirror symmetrical to the wood grain on the back. This helps to generate the impression of a board of solid wood, whose grains on the front side and on the backside are precisely aligned. Thus, e.g. a particularly pronounced wood grain, if desired also a single knothole, can be configured exactly at the same position level on the backside, so that a viewer has the impression that the material sheet is made from a solid piece of wood. The same applies for other components of furniture, e.g. side walls of a large closet, etc.

In order to produce the material sheet at least one decorative layer is used, which includes at least a decorative paper and an embossing on the front side and on the backside of the material sheet. For this purpose, presses are being used, which can perform an embossing on the front side and also on the back side of the material sheet, wherein the press plates that are being used also include a precisely aligned negative structure of the surface to be produced. Through the coincidence of the press plate structure with the decorative paper, the impression of a natural wood grain or of another surface configuration with accordingly raised and lowered portions is produced.

In a particular embodiment of the invention, it is provided that the decorative paper and the embossing have a symmetric structure in longitudinal and/or transversal direction starting in the center. When defining, selecting or producing the decorative papers, particularly simple further processing is provided through a symmetrical structure, which can be configured in longitudinal direction and also in transversal direction, starting in the center. The press plates manufactured precisely configured for this purpose also include a structure of this type, so that a particular advantage is created in that the press plates irrespective of their position can be used in a press as a lower press plate and also as an upper press plate, wherein for further processing, it is not even important if a rotation of the press plates relative to one another in the layer plane is provided or not. This, however, is only achieved when a symmetrical structure is configured in longitudinal direction and also in transversal direction starting at the center. When the structure is only configured symmetrical to the longitudinal direction or the transversal direction, care has to be taken, when the press plates are installed, that a precisely aligned embossing is provided. For this purpose, both sides of a material sheet are covered with a decorative layer and treated with a press plate. Thus, for connecting the particular layers with the substrate layer it is provided that a glue layer is disposed between the substrate layer or the decorative layer at least on one side, preferably on both sides, wherein the glue layer typically made from an amino resin, or the decorative layer is already impregnated with the amino resin, which cures through heating and thus establishes a permanent connection between the decorative layer and the substrate layer.

In order to be able to emboss particularly deep structures, preferably one or plural underlay layers are inserted between the substrate layer and the decorative layer, wherein the underlay layers can e.g. be made from resin impregnated craft paper or resin impregnated multidirectional glass fiber cloth. This provides the option to emboss particularly deep structures without also having to emboss the substrate layer.

In order to be able to achieve particularly high quality surfaces, which are also resistant to conventional cleaning materials, it is furthermore provided that at least a layer sequence of overlay layer and decorative layer is provided on both sides of the material sheet. Eventually, the sensitive decorative layer is protected through the overlay layer, which is typically configured transparent, wherein also the overlay layer can be impregnated with a glue layer, this means impregnated with an amino resin, so that a permanent connection between the overlay layer, decorative layer and substrate layer can be produced.

When high abrasion resistance of the manufactured surfaces of the material sheets is desirable, the decorative layers and/or the overlay layers can be additionally enriched with abrasion resistant particles. Abrasion resistant particles are typically made from corundum, however, also cured melamine or glass can be inserted into one of the upper layers, in order to thus configure the layer more abrasion resistant and stable against wear.

As a matter of principle, materials including wood fibers or wood chips, like e.g. MDF (Medium-Density Fiberboard), HDF (High-Density Fiberboard), particleboard, OSB (Oriented Structure board) or plywood, can be used as substrate layers. The desired quality and strength of the material sheet are crucial parameters in order to be able to use the sheet as a wood material sheet for furniture applications.

Furthermore, it is the object of the present invention to provide a new press plate, which can be used for producing the material sheets. In order to make the handling of the press plates during the press process and in particular during assembly as simple as possible, and in order to assure a precisely aligned embossing of the material sheets on the top side and also on the backside, it is provided that the press plate includes a surface structure, which is configured symmetrical to the longitudinal and/or transversal direction starting in the center. The symmetrical configuration provides that the press plates can be used irrespective of their positional orientation on the bottom and also on the top without incurring the risk of defective embossing due to incorrectly mounted press plates.

### BRIEF DESCRIPTION OF THE DRAWINGS

The invention is subsequently described with reference to drawing figures, wherein:

FIG. 1 illustrates a perspective view of a material sheet;

FIG. 2 illustrates a perspective exploded view of the material sheet with its components and a precisely aligned decorative print;

FIG. 3 illustrates a perspective exploded view of the material sheet with its components and a precisely aligned decorative print similar to FIG. 2 that includes additional underlayers and glue layers; and

FIG. 4 illustrates a top view of a symmetrical press plate for producing material sheets.

### DETAILED DESCRIPTION OF THE INVENTION

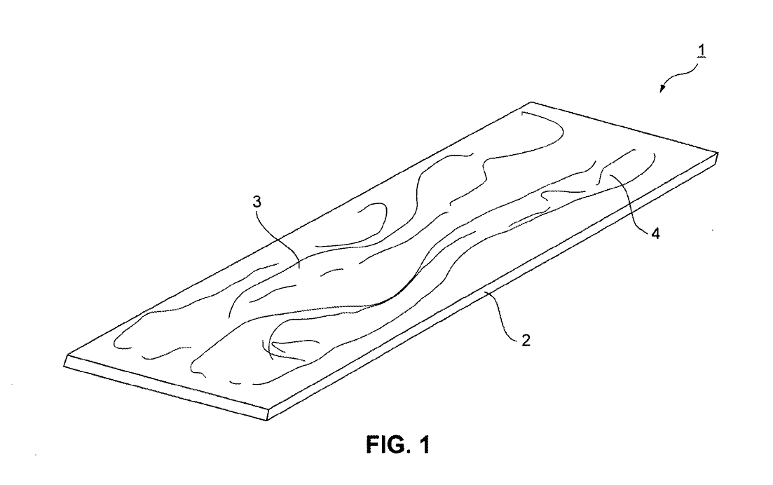

FIG. 1 illustrates a perspective view of a material sheet 1, which is made from a center substrate layer 2 and at least one decorative layer 3, placed on the top side. In the illustrated embodiment, an exemplary wood pattern 4 is illustrated for a decorative layer 3. Certainly, any decorative design can be used for this embodiment of a material sheet 1.

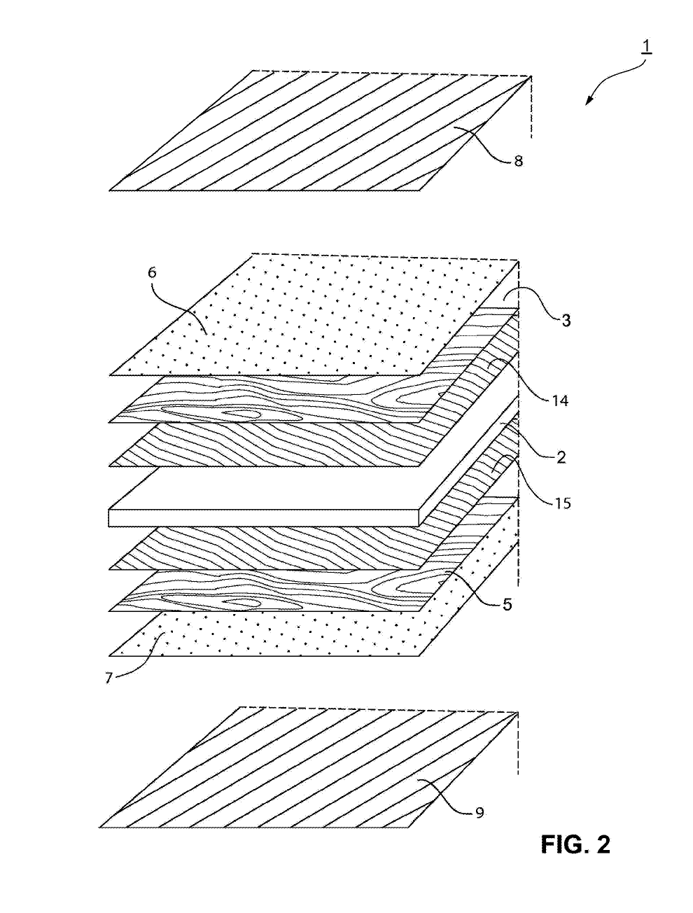

FIG. 2 illustrates a material sheet 1 according to FIG. 1 in a perspective exploded view. From this illustration, it is evident that the material sheet 1 is made from a center substrate layer 2, onto which initially underlay layers 14, 15 are applied on top and also on the bottom. Thereafter come decorative layers 3, 5 and overlay layers 6, 7. The decorative layers 3, 5 thus have a mirror symmetrical pattern, so that the impression of a solid sheet of wood is created, when the material sheet 1 is completed. The decorative layers 3, 5 themselves are covered by the overlay layers 6, 7 and as a consequence of the heating during the pressing process lead to a fixed permanent connection between the overlay layers and the decorative layers, and also between the decorative layers and the underlay layers 14, 15, and between the underlay layers 14, 15 and the substrate layer 2. The underlay layers 14, 15 facilitate a particularly deep embossing of the structures, while the overlay layers 6, 7 simultaneously assure that the surfaces provide sufficient protection against detergents, etc. However, there is no need to provide the overlay layers 6, 7 or possibly additional overlay layers 8, 9, in case only the decorative layer shall be used as an outer layer according to customer requirements.

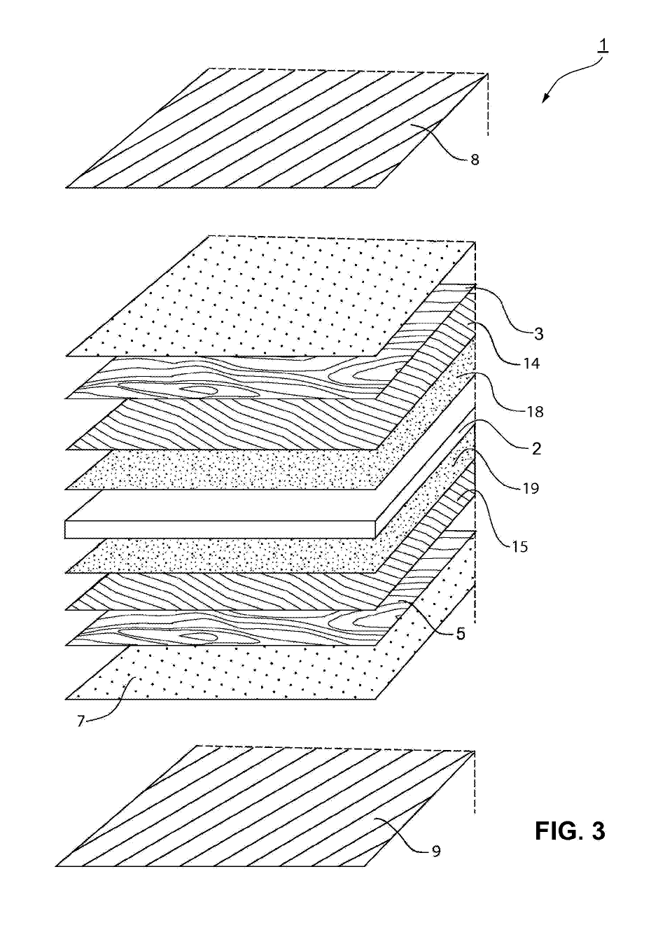

Furthermore, there is the option to vary the sequence of the layers, e.g. initially a glue layer (18, 19) can be placed onto the substrate layer 2, and then onto the decorative layers 3, 5 and subsequently onto the overlay layers 6, 7 and 8, 9. Furthermore, glue layers can be disposed between the particular layers where the layers are not impregnated with amino resin themselves, wherein the glue layers provide the connection after heating and curing. In the present case, the sequence of the particular layers is not the issue, but rather the fact that the decorative layer, no matter in which position it is installed in the layer sequence, has a precisely aligned pattern contour. This is shown in FIG. 3 which illustrates a perspective exploded view of the material sheet with its components and a precisely aligned decorative print similar to FIG. 2.

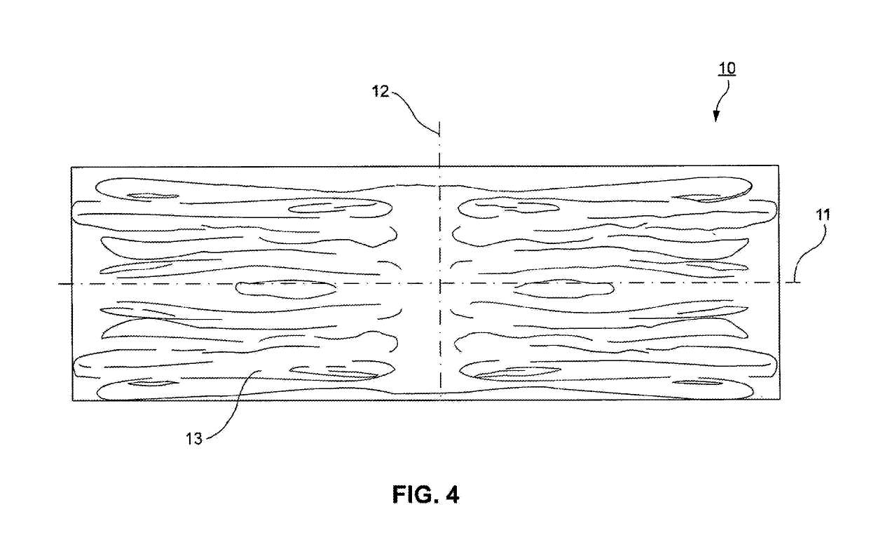

FIG. 4 illustrates a symmetrical press plate 10 in a top view, wherein the press plate has a symmetrical structure 13 along its longitudinal center axis 11 and along its transversal center axis 12. Thus, the structure 13 has been flipped as a mirror image into the other respective quadrants, which provides the essential advantage that the press plate 10 can be used in any desired position as an upper press plate and also as a lower press plate without running the risk that the structures are not configured precisely aligned on top of one another in the completed material sheet.

### REFERENCE NUMERALS AND DESIGNATIONS

1 material sheet
2 substrate layer
3 decorative layer
4 wood grain pattern
5 decorative layer
6 overlay layer
7 overlay layer
8 overlay layer
9 overlay layer
10 press plate
11 longitudinal center axis
12 transversal center axis
13 structure
14 underlay layer
15 underlay layer
18 glue layer
19 glue layer

What is claimed is:

1.-10. (canceled)

11. A method for producing material sheets with press plates, comprising:
providing press plates, each press plate comprising a surface structure which is configured symmetrical to a center of the press plate and extends in a longitudinal or in a transversal direction in a symmetrical manner.

12. The method of claim 11, wherein the surface structure extends in a longitudinal and in the transversal direction in a symmetrical manner.

13. The method of claim 11, wherein the surface structure includes a wood grain pattern.

14. The method of claim 12, wherein the surface structure includes a wood grain pattern.

15. The method of claim 11, wherein the surface structure has a size of 2.3 m×6.0 m.

16. A method for producing material sheets with press plates, comprising:
providing press plates, each press plate comprising a surface structure which is configured symmetrical to a center of the press plate and extends in a longitudinal or in a transversal direction in a symmetrical manner,
wherein the surface structure includes a wood grain pattern, and
wherein each of the material sheets includes:
a center substrate layer; and
a decorative layer disposed on each side of each of the material sheets, and at least on one of the decorative layers is on one side of the center substrate layer, and
providing embossing for each of the material sheets such that structures on both sides of each of the material sheets are configured precisely aligned.

17. The method of claim 16, wherein a relative rotation of the press plates to each other does not alter the structures on both sides of the material sheets.

18. The method of claim 16,
further comprising mounting the press plates in one of plural orientations,
wherein defective embossing due to orientation does not occur for any one of plural orientations of the press plates.

19. A method for producing material sheets with press plates, comprising:
providing press plates, each press plate comprising a surface structure which is configured symmetrical to a center of the press plate and extends in a longitudinal or in a transversal direction in a symmetrical manner,
mounting the press plates in one of plural orientations,
wherein defective embossing due to orientation does not occur for any one of plural orientations of the press plates,
wherein the surface structure includes a wood grain pattern,
wherein the surface structure extends in a longitudinal and in the transversal direction in a symmetrical manner,
wherein the surface structure have a size of 2.3 m×6.0 m, and
wherein each of the material sheets includes:
a center substrate layer; and
a decorative layer disposed on each side of each of the material sheets,
wherein at least on one of the decorative layers is on one side of the center substrate layer, and
further comprising the steps of:
providing embossing for each of the material sheets such that structures on both sides of each of the material sheets are configured precisely aligned.
